(19) United States
(12) Patent Application Publication
(10) Pub. No.: US 2007/0117208 A1
(43) Pub. Date: May 24, 2007

(54) Radiation exposure history indicator

(75) Inventor: Yukiyo Niwa, Kawagoe-shi (JP)

Correspondence Address: OLIFF & BERRIDGE, PLC, P.O. BOX 19928, ALEXANDRIA, VA, 22320, US

(73) Assignee: Nichiyu Giken Kogyo Co., Ltd., Kawagoe-shi, Saitama (JP)

(21) Appl. No.: 10/578,368

(22) PCT Filed: Nov. 5, 2004
(86) PCT No.: PCT/JP04/16784

§ 371 Date: May 5, 2006

(30) Foreign Application Priority Data
Nov. 6, 2003 (JP) 2003-376755
Jun. 3, 2004 (JP) 2004-165608
Sep. 13, 2004 (JP) 2004-264979

(51) Int. Cl. G01N 23/00

(52) U.S. Cl. 436/57; 436/166

(57) ABSTRACT

A radiation exposure history indicator sheet comprises a base material sheet which has a color-changing layer on at least a part of the surface comprising: a polymer compound having a hydroxyl group and at least one group selected from a halogen group and an acetal group; a coloring organic electron donor compound; an active species-generating organic compound for making the organic electron donor compound colored by a radiation; and a radiation absorbent and/or a radiation-excite fluorescent agent.

### TECHNICAL FIELD

This invention relates to a radiation exposure history indicator sheet which can show radiation dose irradiated in a case of sterilization of a medical instrument or blood for transfusion, or medical examination or treatment through hanging a color hue, and which permits a distinctive recognition of a color hue after changing and which never undergoes any color fading. This invention also relates to a method of dosimetry of the exposed dose in order to confirm safety of a patient when a medical examination or treatment using radiation is performed.

### BACKGROUND ART

The radiation exposure treatments such as an application of X-rays or gamma-rays have in general been used for the sterilization of medical instrument, and these treatments have recently been applied to the blood for transfusion in order to prevent any crisis of graft-versus-host diseases (TA-GVHD) due to the blood for transfusion.

In general, to examine whether a desired radiation dose is irradiated to a subject to be irradiated such as a medical instrument for sterilization or blood for transfusion or not, radiation ray is irradiated to the subject under the coexistence of an indicator including a substance, which undergoes an irreversible color change upon exposure to the ray, and after the radiation exposure, the indicator is withdrawn from the subject to confirm the color change thereof. As such an indicator, a composition for a radiation exposure history indicator, whose color fading is prevented by blending a hydrophilic compound, is mentioned in Japanese Patent Provisional Publication No. 2000-346945. An indicator which can show a color change when the radiation exposure dose is from 15 Gy of a little radiation exposure dose level for the blood for transfusion, to 25,000 Gy of much radiation exposure dose level for the medical instrument, is mentioned in Japanese Patent Provisional Publication No. 2000-131438.

The radiation exposure treatment through the radiation such as X-ray is performed in order to judge a lesion exactly, or to medicate locally, as well as sterilization for the medical examination or treatment. Especially Interventional Radiology (IVR) is a medical treatment method that the radiation is irradiated by an endermic technique under picture guidance. In the IVR method, the burden to a patient is small and there is little invasion. The radiation dose to the patient in the IVR method is comparatively large. So when the medical treatment by IVR method is repeated, the radiation dose to the patient must not be excessive and the patient must not get a radiation injury. It is important that the radiation dose irradiated to the patient is managed strictly by measuring and predicting it exactly.

However, when a conventional indicator is used, 15 Gy to 25000 Gy of the radiation dose for sterilization or irradiating to the blood for transfusion is confirmed by changing color thereof, but it is difficult to confirm 5 Gy or less of the radiation dose for medical treatment using radiation.

Therefore, it had been confirmed that a human body was not exposed to excessive radiation dose by a troublesome, complicated method that was hard to deal with, when the medical treatment using radiation was performed. For example, an expensive and large-scale exposed dose measurement equipment such as a transmission dose meter (ionization chamber) for measuring an areal dose, a semiconductor detector or a scintillation detector was put on the patient and the radiation dose was measured, and then a radiation dose distribution was determined using a detection value, or the radiation dose was estimated by attaching an expensive film for X-ray measurement to the patient.

As a method for measuring exposed dose without using such equipment or film for X-ray measurement, a label-like color dosimeter containing a photochromic material comprising a luminous body which emits light by radiation irradiation and a diarylethene compound, is mentioned in Japanese Patent Provisional Publication No. 2003-64353.

An inexpensive radiation exposure history indicator sheet which can measure the radiation dose much more correctly and simply, and can be stored over a long period of time as the evidence, and a method for measuring the exposed dose correctly and simply not only at a specific body part of a patient but also at extensive arbitrary parts thereof using the indicator sheet, are desired.

The present invention has been developed to solve the foregoing problems. It is an object of the present invention to provide an inexpensive and simple radiation exposure history indicator sheet which can show the radiation dose irradiated extensively by changing a color hue clearly, and which does not cause any color fading even if it is stored over a long period of time. It is another object of the present invention to provide a simple method for measuring the exposed dose correctly and safely at extensive body parts without using a large-scale radiation dose measurement equipment.

### DISCLOSURE OF INVENTION

A polymer compound agent for a radiation exposure history indicator of the present invention developed for accomplishing the foregoing object is explained. The polymer compound agent for a radiation exposure history indicator comprises a polymer compound having a hydroxyl group and at least one group selected from a halogen group and an acetal group.

It is preferable that the polymer compound is at least one selected from

a polymer compound represented by the following chemical formula (1) 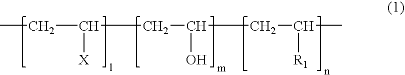
(in above formula, —X is a halogen atom; —R₁ is a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; l, m and n are arbitrary ratios), and

a polymer compound represented by the following chemical formula (2) 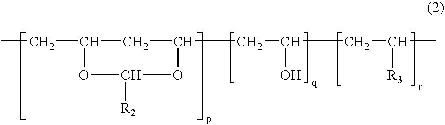
(in above formula, —R₂ and —R₃ are the same or different to each other, and are a hydrogen atom, a cyano group, an alkyl group, an aryl group, an alkoxyl group, an alkoxycarbonyl group, a fatty carbonyloxy group such as acetoxy group, a carboxyl group, an aryloxy group, an aralkyl group, an aralkoxyl group; p, q and r are arbitrary ratios).

A composition for the radiation exposure history indicator of the present invention can be colored by irradiating radiation. The composition comprises:

a polymer compound having a hydroxyl group and at least one group selected from a halogen group and an acetal group;

a coloring organic electron donor compound;

an active species-generating organic compound for making the organic electron donor compound colored by a radiation; and

a radiation absorbent and/or a radiation-excite fluorescent agent.

Or the composition for the radiation exposure history indicator comprises at least one compound selected from a polyacetylene compound and diarylethene compound.

It is preferable that the polymer compound in the composition for the radiation exposure history indicator is at least one selected from the polymer compound represented by the chemical formula (1) and the polymer compound represented by the chemical formula (2).

These polymer compounds may be used solely or blended plurally, or may be mixed with another polymer compound.

The coloring organic electron donor compound in the composition for the radiation exposure history indicator is preferably at least one member selected from the group consisting of triphenylmethane phthalides, fluorans, phenothiazines, indolyl phthalides, leucoauramines, Rhodamine lactams, Rhodamine lactones, indolines, and triaryl methanes.

These coloring organic electron donor compounds are usually colorless or slightly colored, and can develop a peculiar color through the action of active species such as Brønsted acids and Lewis acids, i.e., an electron donor. These coloring organic electron donor compounds may be used solely or blended plurally. More specifically, examples of triphenylmethane phthalides are Crystal Violet lactone and Malachite Green lactone; examples of fluorans are 3-diethylaminobenzo-alpha-fluoran, 3-diethylamino-7-chlorofluoran, 3-diethylamino-7-dibenzylaminofluoran and 3,6-dimethoxyfluoran; example of phenothiazines is 3,7-bisdimethylamino-10-(4′-aminobenzoyl)phenothiazine; examples of indolyl phthalides are 3,3-bis(1-ethyl-2-methylindol-3-yl)phthalide and 3,3-bis(1-n-butyl-2-methylindol-3-yl)phthalide; examples of Leucoauramines are N-(2,3-dichlorophenyl) Leucoauramine and N-phenyl Auramine; example of Rhodamine lactams is Rhodamine-beta-o-chloroaminolactam; example of Rhodamine lactones is Rhodamine-beta-lactone; examples of indolines are 2-(phenyliminoethanedilidene)-3,3′-dimethyl indoline, p-Nitrobenzyl Leucomethylene Blue and Benzoyl Leucomethylene Blue; and examples of triaryl methanes are bis(4-diethylamino-2-methylphenyl)phenylmethane and tris(4-diethylamino-2-methylphenyl)methane.

The active species-generating organic compound in the composition for the radiation exposure history indicator preferably has a halogen group.

The active species-generating organic compound can irreversibly generate active species by irradiating radiation. And specific examples thereof are halogenated alkyl derivatives such as carbon tetrabromide, tribromoethanol and tribromomethyl phenyl sulfone; and tribromomethyl derivatives.

The radiation absorbent in the composition for the radiation exposure history indicator is preferably at least one member selected from the group consisting of metals such as barium, yttrium, silver, tin, hafnium, tungsten, platinum, gold, lead, bismuth, zirconium, europium and cerium; and compounds containing these metals. Specific examples of these compounds containing such metals are sulfates, carbonates and nitrates. These metals and/or the compounds may be used solely or blended plurally.

The radiation-excite fluorescent agent in the composition for the radiation exposure history indicator is preferably at least one selected from the group consisting of salts represented by CaWO₄, MgWO₄, and HfP₂O₇; calcined products represented by ZnS:Ag, ZnCdS:Ag, CsI:Na, CsI:Tl, BaSO₄:Eu²⁺, Gd₂O₂S:Tb³⁺, La₂O₂S:Tb³⁺, Y₂O₂S:Tb³⁺, Y₂SiO₅:Ce, LaOBr:Tm³⁺, BaFCl:Eu²⁺, and BaFBr:Eu²⁺. These salts and/or calcined products may be used solely or blended plurally.

As the radiation-excite fluorescent agent, ZnS:Ag of the calcined product is produced by adding silver as a heavy metal activator to zinc sulfide as a principal component, and then calcined. Other calcined products can be prepared by the same procedure.

Examples of the polyacetylene compound in the composition for the radiation exposure history indicator are diacetylene compound, more specifically, carbazoles having diacetylene group.

Examples of the diarylethene compound in the composition for the radiation exposure history indicator are a diarylethenes illustrated diarylperfluorocyclopentene having aryl group which may be substituted with the substituent such as alkyl group, alkoxyl group, halogen group, aryl group or heteroaryl group at 1- and 2-positions thereof; a diheteroarylethenes illustrated a diheteroarylperfluorocyclopentene having heteroaryl group which may be substituted with the substituent such as alkyl group, alkoxyl group, halogen group, aryl group or heteroaryl group at 1- and 2-positions thereof; more specifically, diheteroarylethenes such as 1,2-bis [2-methoxy-5-phenyl-3-thienyl]perfluorocyclopentene.

The composition for the radiation exposure history indicator preferably comprises 5 to 50 parts by weight of the polymer compound, 0.01 to 50 parts by weight of the coloring organic electron donor compound, 0.1 to 50 parts by weight of the active species-generating organic compound, and 0.1 to 500 parts by weight of the radiation absorbent and/or the radiation-excite fluorescent agent.

The color hue and contrast of the color observed after the color change as well as the rate of color change can be controlled variously by adjusting the kinds and mixing ratio of the components in the composition for the radiation exposure history indicator.

The composition for the radiation exposure history indicator may be prepared as ink for the radiation exposure history indicator including a solvent. The composition for the radiation exposure history indicator may be prepared as ink including a medium which the polymer compound is dissolved in a solvent.

The medium preferably comprises 50 to 95 parts by weight of the solvent per 5 to 50 parts by weight of the polymer compound.

All the solvents which can dissolve the polymer compound are used. The solvent is preferably at least one selected from the group consisting of methanol, ethanol, isopropanol, butyl alcohol, hexyl alcohol, methyl acetate, ethyl acetate, propyl acetate, isobutyl acetate, butyl acetate, acetone, 2-butanone, cyclohexane, isophorone, methyl ethyl ketone, 4-methyl-2-pentanone, ethyl ether, isopropyl ether, tetrahydrofuran, dioxane, methyl cellosolve, ethyl cellosolve, butyl cellosolve, 2-hexane, isooctane, solvent naphtha, methylene chloride, propylene chloride, ethylene chloride, chloroform, dichloroethane, 1,1,2-trichloroethane, carbon tetrachloride, benzene, toluene, xylene, chlorobenzene, N,N-dimethyl formamide, N-methyl-2-pyrrolidone, dimethyl sulfoxide, and acetic acid. These solvents may be used solely or blended plurally.

The composition for the radiation exposure history indicator may include another solvent, a resin, a defoaming agent, a surface active agent, an additive, and a coagulant.

The composition for the radiation exposure history indicator may be used as an indicator by directly applying or printing to a subject to be irradiated, or may be used as an indicator by enclosing into a microcapsule, a container with a lid made of resin or glass, or a sealed tube made of resin or glass.

A radiation exposure history indicator sheet of the present invention comprises a base material sheet which has a color-changing layer on at least a part of the surface of a base material sheet comprising:

a polymer compound having a hydroxyl group and at least one group selected from a halogen group and an acetal group;

a coloring organic electron donor compound;

an active species-generating organic compound for making the organic electron donor compound colored by a radiation; and

a radiation absorbent and/or a radiation-excite fluorescent agent.

The color-changing layer comprises, for example, the composition or the ink.

It is preferable that the polymer compound used for the radiation exposure history indicator sheet is at least one selected from the polymer compound represented by the chemical formula (1) and the polymer compound represented by the chemical formula (2).

It is preferable that the color-changing layer in the radiation exposure history indicator sheet is prepared by applying the ink or the composition for the indicator onto the base material sheet made of paper or resin.

The radiation exposure history indicator sheet may comprise dye on at least a part of color-changing layer, whose color hue is similar to the color hue of the color-changing layer observed prior to or after changing the color.

It is preferable that the ink comprising the dye is printed onto the color-changing layer, or that the sheet comprising the dye is put on the color-changing layer. Furthermore, the radiation dose can be estimated with more high accuracy by using two or more kinds of contrast color hues after changing color corresponding to the amounts of irradiated radiation.

The color-changing layer in the radiation exposure history indicator sheet may be covered with a transparent or translucent protective film layer.

The protective film is used in order to intercept an ultraviolet ray. Examples of the protective film are a polyimide film, a polyethylene terephthalate film, a polypropylene film, a polyester film, and these films with an ultraviolet ray absorbent by mixing or laminating thereof.

The protective film may cover all over the color-changing layer, or may cover a mere part of the color-changing layer. The protective film having an adhesive layer may adhere to the color-changing layer on the base material sheet through the adhesive layer.

It is furthermore preferable that the adhesive layer is prepared on the non-observation plane of the indicator sheet. When the protective sheet covers the color-changing layer on observation plane of the indicator sheet and the base material sheet with overlapping, the adhesive layer may be prepared on the non-observation planes of the indicator and the overlapping protective sheet. Dye, whose color hue is similar to that observed on the color-changing layer prior to or after changing the color, may be comprised on the protective film layer.

Moreover, the indicator sheet may be enclosed with the protective film.

Dye, whose color hue is similar to the color hue of the color-changing layer observed prior to or after changing the color, may be comprised on at least part of either side of the protective film layer of the radiation exposure history indicator sheet.

Dye, whose color hue is similar to the color hue of the color-changing layer observed prior to or after changing the color, may be comprised on at least part of either side of the protective film sheet of the radiation exposure history indicator sheet.

In the radiation exposure history indicator sheet, the base material sheet may be also a protective film sheet, and an adhesive layer may be prepared on the non-observation plane of the protective film sheet.

Another base material sheet may be adhered to the color-changing layer prepared on the non-observation planes of the base material sheet as the protective film sheet through the adhesive layer prepared on the non-observation planes of the color-changing layer. Furthermore, the base material sheet as the protective film sheet may be covered with another protective film sheet. And another adhesive layer may be prepared on the non-observation planes of the concerned another base material sheet.

Dye, whose color hue is similar to the color hue of the color-changing layer observed prior to or after changing the color, may be comprised on at least part of either side of the protective film sheet, or a sheet comprising the dye may be put on the protective film sheet.

It is preferable that the base material sheet is made of resin or paper. Examples of the resin are polyester, polystyrene, polycarbonate, polyethylene terephthalate, polyimide and polypropylene.

In the radiation exposure history indicator sheet, another base material sheet may be adhered to the adhesive layer.

In the radiation exposure history indicator sheet, the adhesive layer may be prepared on the non-observation plane of the base material sheet.

The indicator sheet placed on the vicinity of a subject to be irradiated with radiation upon a radiation exposure treatment undergoes a color change to an extent, which varies depending on the radiation exposure dose to thus develop a variety of color hue according to the radiation exposure history. The prescribed color hue developed by the indicator sheet indicates that a desired level of the radiation dose is irradiated to the subject to be irradiated. The indicator sheet after changing colors never undergoes any color fading and any change of the color hue, so the indicator sheet can be stored as the evidence of radiation exposure history.

Since a shape of the radiation exposure history indicator sheet is in a sheet shape, the indicator sheet can be easily stuck on a measuring region. The radiation exposure history indicator sheet can show the radiation dose irradiated to a medical instrument or blood for transfusion for sterilization by the color change thereof. And furthermore, a position of radiation irradiation or the radiation dose can be confirmed easily by attaching the indicator to a human body in a case of radiation medical examination or treatment. The radiation exposure history indicator sheet can be used for confirmation of a little radiation dose in the medical examination or treatment field because the indicator sheet can show the color change under a wide range of 0.05 Gy to 25000 Gy of radiation dose.

The indicator sheet after changing the colors never undergoes any color fading. Therefore, the indicator sheet can be stored for long period of time as the evidence which shows that the desired radiation dose has been irradiated.

A method of dosimetry of exposed dose of this invention comprises steps of:

an exposed dose indicator containing a composition for a radiation exposure history indicator is attached to at least one of an exposing body selected from skin of a patient, a clothing for an operation, a hat for an operation, sheets for an operation, and the exposing body is exposed;

after exposure, the exposed dose is measured by comparing a coloring of the exposed dose indicator with a standard color that radiation dose which is equivalent to the exposed dose was irradiated to the same kind of indicators, and the indicators were colored beforehand.

According to the method of dosimetry of exposed dose, the local exposed dose of the exposing body or the total exposed dose of the exposing body as a whole can be measured easily and precisely.

It is preferable that the above-mentioned composition for the radiation exposure history indicator is used for the method of dosimetry of exposed dose. It is also preferable that the above-mentioned polymer compound, the coloring organic electron donor compound, the active species-generating organic compound, the radiation absorbent, the radiation-excite fluorescent agent, the polyacetylene compound and the diarylethene compound are used in the composition.

The exposed dose indicator comprising the composition is colored promptly with sufficient reproducibility corresponding to the exposed dose. Therefore, according to the method, the exposed dose of the exposing body can be measured precisely and easily by the coloring color hue and contrasts of colors on real time.

In the method of dosimetry of the exposed dose, the exposed dose indicator may be attached all over the exposing body.

The indicator may be attached all over the surface of the exposing body homogeneously, or may be attached to the surface of the exposing body with every regular intervals. And an exposed range and an exposed dose distribution of the patient can be measured precisely.

In the method of dosimetry of the exposed dose, the colors may be compared by comparing measured values of a color difference measurement, a concentration reflection measurement, an absorbance measurement, a transmittance measurement, or by visual observation.

As the comparison of measured values, the measured value, which is obtained from the above-mentioned measurement of the colored exposed dose indicator, is compared with a calibration curve. The calibration curve is prepared using preliminary irradiated radiation doses and preliminary measured values. The preliminary measured value is obtained from the same measurement after obtaining a standard color of the indicator by irradiating various radiation doses which are equivalent to the exposed dose using the same kind of indicators. The quantitative exposed dose is measured precisely and easily from the calibration curve.

As the comparison of visual observation, the color hue of the colored exposed dose indicator is compared by visual observation with a color sample about a standard color of the indicator. The color sample is obtained by irradiating various radiation dose which is equivalent to the exposed dose using the same kind of indicators. The exposed dose is determined precisely and easily from the color sample.

In the method of dosimetry of the exposed dose, the exposed dose indicator may be a paint comprising the composition, a label having the composition, a sheet having the composition, or a molding having the composition.

The paint-type exposed dose indicator is used by applying or spraying to the arbitrary regions of the exposing body such as skin of a patient, clothing illustrated by clothes for an operation or a hat for an operation, or the sheets which covers the patient or an operating table. The label-type, the sheet-type and the molding-type exposed dose indicators are used by attaching to or twisting around skin of a patient, clothing or sheets, or by attaching or putting on the equipment such as an operating table.

The range of the exposure can be presumed precisely when the position where the exposed dose indicator is attached is set up beforehand according to the position of the exposing body to be measured, or according to the measuring range.

In the method of dosimetry of the exposed dose, it is preferable that the coloring is the change of the color hue, or the change of the contrast of the color hue. It is easy to observe the change of the color hue or the change of the contrast of the color hue visually, so the exposed dose of the wide range of regions can be visually discriminated because the region where the more radiation is irradiated shows the specific color hue or the deep color hue.

According to the method of dosimetry of the exposed dose, the measuring of the exposed dose is intelligible, easy and precise because the clear change of the color hue of the exposed dose indicator is observed visually and the exposed dose is measured on real time.

The distribution of the exposed dose can be confirmed by the color hue and the contrast of a color hue at a glance when the exposed dose indicator is applied or attached to the body of the patient widely. When a spectroscopic measurement is used, the exposed dose can be measured much more correctly.

The exposed dose indicator can be attached to the patient easily because it is the paint, the label, the sheet, or the molding.

This dosimetry method is inexpensive, and can be used widely. This dosimetry method can be performed at every radiation medical examination or treatment. Furthermore, this dosimetry method can be performed for a safety control by measuring the cumulative exposed dose of a radiation engineer as well as the patient as the method can be used continuously.

It is assumed that the both indicator of the color fading of the indicator sheet such as the radiation exposure history indicator and the exposed dose indicator is inhibited by the following mechanism, although the details thereof have not yet been clearly elucidated. That is, when radiation is applied to the indicator, the radiation absorbent present in the indicator absorbs and scatters the radiation to thus cause a phenomenon wherein electrons are emitted and paired electrons are formed through the photoelectric effect and the Compton effect. Alternatively, the radiation excited fluorescence-emitting agent absorbs radiation irradiated onto the indicator to thus cause a phenomenon similar to that observed for the radiation absorbent and to simultaneously cause fluorescence-phosphorescence-emitting phenomenon. These phenomena would proceed the reaction wherein active species are generated from the active species-generating organic compound. The resulting active species have an electron-receiving ability and accordingly, induce the charge transfer phenomenon of the co-existing coloring organic electron donor compound. For this reason, the electron donor compound develops a peculiar color because of the change of the electron density and this in turn results in the color change of the indicator. Simultaneously, the electron receptor such as a hydrogen ion is generated from the hydroxyl group in the polymer compound represented by the above-mentioned chemical formula by irradiating the radiation thereto, and then the electron receptor would stabilize the coloring organic electron donor compound to thus inhibit any color fading of the indicator. Especially, it is assumed that the electron receptor such as the hydrogen ion is easy to generate because hydroxyl group in the polymer compound co-exists with halogen group or acetal group.

Accordingly, the indicator after changing the color can be stored over a long period of time with changed color hue.

Furthermore, these indicators can show a quite wide range of radiation dose extending from 0.05 Gy to 25,000 Gy and can change colors thereof at lower dose than conventional dose. Although the details thereof have not yet been clearly elucidated, it is assumed that the color of the indicator can be changed at the lower dose by the following reason. That is, the polymer compound has an effect of stabilizing the colored organic electron donor compound, and a deal of such polymer compounds are comprised in the composition.

### BRIEF DESCRIPTION OF DRAWINGS

FIG. 1 is a sectional view showing the example of the radiation exposure history indicator applying the present invention.

FIG. 2 is a sectional view showing another example of the radiation exposure history indicator applying the present invention.

FIG. 3 is a plane view showing a state of the use of the example of the radiation exposure history indicator applying the present invention.

FIG. 4 is a plane view showing another state of the use of the example of the radiation exposure history indicator applying the present invention.

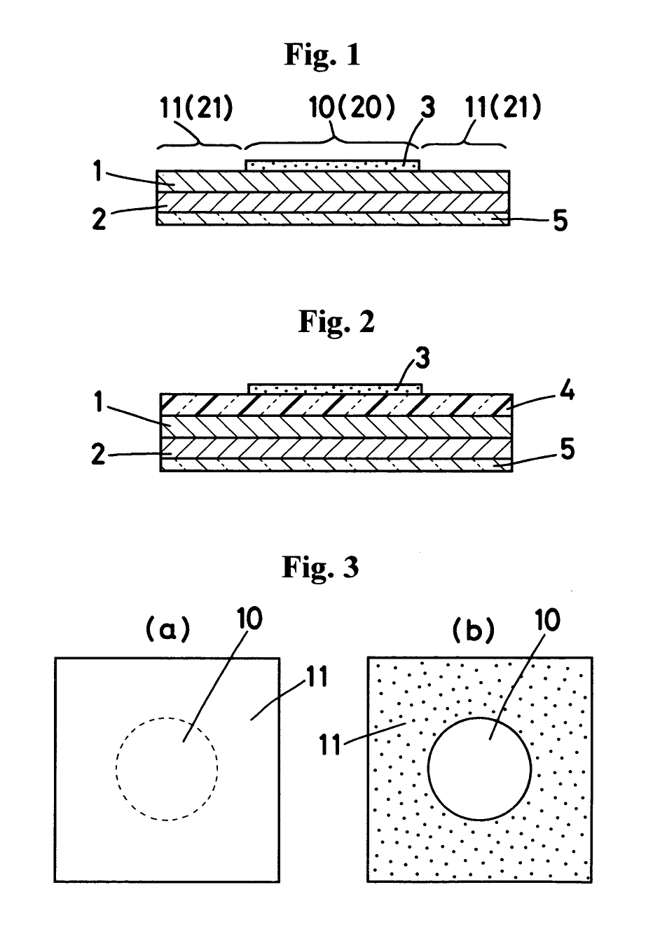

### MODE FOR CARRYING OUT THE INVENTION

Hereunder, the embodiments of the present invention are explained in detail, but the range of the present invention is not limited to these embodiments.

The radiation exposure history indicator sheet is prepared as follows.

First, a medium is prepared by dissolving 5 to 50 parts by weight of a polymer compound having a hydroxyl group and at least one group selected from a halogen group and an acetal group into 50 to 95 parts by weight of a solvent. To the prepared medium, 0.01 to 50 parts by weight of a coloring organic electron donor compound, 0.1 to 50 parts by weight of an active species-generating organic compound and 0.1 to 500 parts by weight of a radiation absorbent and/or a radiation-excite fluorescent agent is added. It is mixed homogeneously to obtain a composition for the radiation exposure history indicator as ink.

The obtained composition for indicator is applied onto a surface of a base material sheet made of plastics to form a color-changing layer. And then, a radiation exposure history indicator sheet is obtained. The patterns and the characters may be printed onto the color-changing layer using the ink comprising dye on at least a part of color-changing layer, whose color hue is similar or the same to the color hue of the color-changing layer observed prior to or after changing the color.

The indicator is attached to a subject to be irradiated with radiation, and radiation such as X-ray or gamma-ray is irradiated thereto. After the irradiation is completed, the indicator is withdrawn from the subject. It is confirmed that a desired level of the radiation dose was irradiated to the subject because of the change of the color hue of the indicator. The indicator after changing the color never undergoes any color fading, so the indicator can be stored over a long period of time with changed color hue as the evidence that the desired level of the radiation dose was irradiated.

Or, the indicator sheet is placed in the vicinity of the exposing body such as a body position where a radiation medical examination or treatment for the patient is performed, and then the radiation is irradiated thereto. After exposure, the exposed dose is measured by comparing a color of the exposed dose indicator which shows different color hue or different contrast of the color hue depending on the exposed dose thereof, with a standard color of the indicator, which a variety of radiation dose is irradiated to the same kind of indicators and makes the indicators show the different color hue or different contrast of the color hue every radiation dose beforehand.

In addition, the exposed dose indicator may be ink for which the composition for the radiation exposure history indicator is applied or printed onto the exposing body directly, or may be a sheet or a label which the composition for the radiation exposure history indicator is applied to a base material made of plastics or paper, or may be a molding which the composition for the radiation exposure history indicator is molded, or may be a molding which the composition for the radiation exposure history indicator enclosed into a microcapsule, a container with a lid made of resin or glass, or a sealed tube made of resin or glass is attached or put onto the exposing body.

As an example of the composition for the radiation exposure history indicator in the indicator sheet used as the exposed dose indicator, the example of the composition comprising the polymer compound, the coloring organic electron donor compound, the active species-generating organic compound and the radiation absorbent and/or the radiation-excite fluorescent agent is explained. In addition, the composition may comprise a polyacetylene compound and a diarylethene compound in order to make it be colored.

Embodiments of the present invention are explained more concretely, referring to figures.

FIG. 1 is a sectional view showing an example of the radiation exposure history indicator sheet applying the present invention. The radiation exposure history indicator sheet has the color-changing layer 1 on the surface of the base material sheet 2, as shown in FIG. 1. On the color-changing layer 1, the patterns or the characters are printed using the ink comprising the dye 3 whose color hue is similar to that of color-changing layer 1. As shown in FIG. 3(a), it is impossible to distinguish the printed part of the pattern 10 from the non-printed part 11 visually because the color hue of the printed part of the pattern 10 is similar to that of the non-printed part 11. The base material sheet 2 has the adhesive layer 5 on the non-observation plane thereof.

When the radiation is irradiated, the indicator sheet is attached to a subject to be irradiated with radiation, and radiation such as X-ray or gamma-ray is irradiated thereto. After the irradiation is completed, the indicator is withdrawn from the subject. The state of the indicator sheet at this time is shown in FIG. 3(b). The color-changing layer 1 is colored by irradiation of the radiation, but at the printed part of the pattern 10, only the color hue of the ink is observed. On the other hand, the changed color hue of the color-changing layer 1 is observed at the non-printed part 11. Consequently, the printed part of the pattern 10 appears as the pattern whose inside is different color hue from that of the non-printed part 11. Therefore, it is confirmed that a desired level of the radiation dose was irradiated.

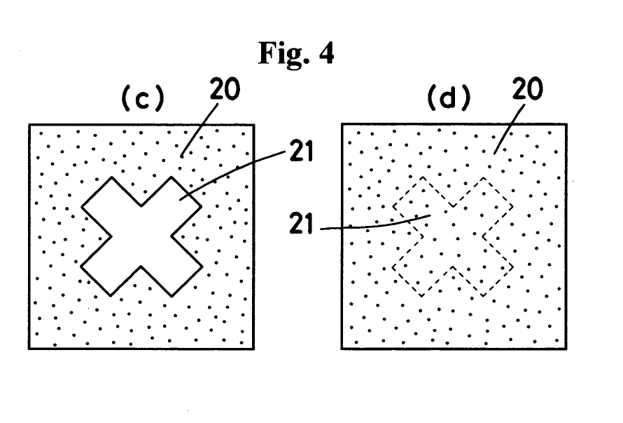

In addition, a form of a pattern whose inside is non-printed may be printed onto the indicator sheet using ink comprising the dye 3 whose color hue is similar to changed color hue of color-changing layer 1, as shown in FIG. 4(c). Before irradiating the radiation, the non-printed part 21 appears as the pattern whose inside is different color hue because the color hue of the printed part of the pattern 20 is different from the color hue of the non-printed part of the pattern 21. When the radiation is irradiated to the indicator, the changed color hue of the color-changing layer 1 is observed at the non-printed part 21 and the color hue thereof is similar to the color hue of the printed part of the pattern 20, as shown in FIG. 4(d). Therefore, the pattern disappears.

Hereunder, examples of manufacturing the indicators are explained. Examples of manufacturing the indicator sheet using the composition for radiation exposure history indicator applying the present invention are mentioned in Examples 1 to 7. Examples of manufacturing the indicator sheet using the composition for radiation exposure history indicator not applying the present invention are mentioned in Comparative Examples 1 to 4.

### EXAMPLE 1

Vinyl chloride-vinyl acetate-polyvinyl alcohol copolymer as a polymer compound was dissolved in a mixture solvent of toluene/ethanol (1:1) to prepare a medium of 25% solution. To 100 parts by weight of the prepared medium, 10 parts by weight of 2-(2-chloroanilino)-6-dibutylaminofluoran of fluorans as a coloring organic electron donor compound, 10 parts by weight of tribromoethanol as an active species-generating organic compound and 20 parts by weight of cerium oxide as a radiation absorbent were added and mixed, to obtain a composition for radiation exposure history indicator as ink.

The composition was applied to a base material sheet of polyethylene film, to obtain an indicator sheet.

### EXAMPLE 2

An indicator sheet was prepared by the same procedure used in Example 1 except that poly(vinyl butyral) was used as the polymer compound.

### EXAMPLE 3

An indicator sheet was prepared by the same procedure used in Example 2 except that ethanol was used as the solvent.

### EXAMPLE 4

An indicator sheet was prepared by the same procedure used in Example 2 except that 3,3-bis(1-n-butyl-2-methylindol-3-yl)phthalide was used as the coloring organic electron donor compound.

### EXAMPLE 5

An indicator sheet was prepared by the same procedure used in Example 2 except that tribromomethyl phenyl sulfone was used as the active species-generating organic compound.

### EXAMPLE 6

An indicator sheet was prepared by the same procedure used in Example 2 except that barium sulfate was used as the radiation absorbent.

### EXAMPLE 7

An indicator sheet was prepared by the same procedure used in Example 1 except that a mixture specified in Table 1 was used as the polymer compound.

### COMPARATIVE EXAMPLES 1 TO 4

Indicator sheets were prepared by the same procedure used in Example 1 except that a polymer compound, which was not a polymer compound having a hydroxyl group and at least one group selected from a halogen group and an acetal group, specified in Table 1 was used as the polymer compound.

The indicator sheets prepared in Examples 1 to 7 and Comparative Examples 1 to 4 were exposed to X-rays at the dose of 5 Gy using an X-ray exposure device: MBR-1520A-2 (available from Hitachi Medico Co., Ltd.). Then, these indicator sheets were withdrawn from the exposure device, stored in an incubator maintained at 40° C. for 3 weeks and visually inspected for any change in their color hues. The results thereof are shown in Table 1. In addition, when these indicator sheets were exposed to gamma-rays using a gamma-ray exposure device: IBL437C (available from Nihon Schering K.K.), the same results as Table 1 were obtained.

TABLE 1

| | | | | | | Radiation | | | |
|---|---|---|---|---|---|---|---|---|---|
| | | | | | Active | Absorbent/ | Color Hue of | | |
| | | | | Coloring | Species- | Radiation- | Prior to/after | | |
| | | Medium | | Electron | Generating | Excite | irradiation | | |
| | | Polymer | | Donor | Organic | Fluorescent | | | After 3 |
| | | Compound | Solvent | Compound | Compound | Agent | Prior | After | weeks |
| Ex. | 1 | Vinyl chloride | Toluene/ | 2-(2-Chloro- | Tribromo- | Cerium | White | Black | Black |
| | | vinyl acetate | Ethanol | anilino)-6- | ethanol | oxide | | | |
| | | polyvinyl | | dibutylamino- | | | | | |
| | | alcohol | | fluoran | | | | | |
| | | copolymer | | | | | | | |
| | 2 | Poly | Toluene/ | 2-(2-Chloro- | Tribromo- | Cerium | White | Black | Black |
| | | (vinyl butyral) | Ethanol | anilino)-6- | ethanol | oxide | | | |
| | | | | dibutylamino- | | | | | |
| | | | | fluoran | | | | | |
| | 3 | Poly | Ethanol | 2-(2-Chloro- | Tribromo- | Cerium | White | Black | Black |
| | | (vinyl butyral) | | anilino)-6- | ethanol | oxide | | | |
| | | | | dibutylamino- | | | | | |
| | | | | fluoran | | | | | |
| | 4 | Poly | Toluene/ | 2-(2-Chloro- | Tribromo- | Cerium | White | Red | Red |
| | | (vinyl butyral) | Ethanol | anilino)-6- | ethanol | oxide | | | |
| | | | | dibutylamino- | | | | | |
| | | | | fluoran | | | | | |
| | 5 | Poly | Toluene/ | 2-(2-Chloro- | Tribromo- | Barium | White | Black | Black |
| | | (vinyl butyral) | Ethanol | anilino)-6- | methyl- | sulfate | | | |
| | | | | dibutylamino- | phenyl | | | | |
| | | | | fluoran | sulfone | | | | |
| | 6 | Poly | Toluene/ | 2-(2-Chloro- | Tribromo- | Cerium | White | Black | Black |
| | | (vinyl butyral) | Ethanol | anilino)-6- | ethanol | oxide | | | |
| | | | | dibutylamino- | | | | | |
| | | | | fluoran | | | | | |
| | 7 | Mixture of | Toluene/ | 2-(2-Chloro- | Tribromo- | Cerium | White | Black | Black |
| | | Poly(vinyl | Ethanol | anilino)-6- | ethanol | oxide | | | |
| | | butyral)/ | | dibutylamino- | | | | | |
| | | ethyl | | fluoran | | | | | |
| | | cellulose(1:1) | | | | | | | |
| Comp | 1 | Vinyl chloride | Toluene/ | 2-(2-Chloro- | Tribromo- | Cerium | White | Black | White |
| Ex. | | vinyl acetate | Ethanol | anilino)-6- | ethanol | oxide | | | |
| | | copolymer | | dibutylamino- | | | | | |
| | | | | fluoran | | | | | |
| | 2 | Ethyl | Toluene/ | 2-(2-Chloro- | Tribromo- | Cerium | White | Black | White |
| | | cellulose | Ethanol | anilino)-6- | ethanol | oxide | | | |
| | | | | dibutylamino- | | | | | |
| | | | | fluoran | | | | | |
| | 3 | Vinyl | Toluene/ | 2-(2-Chloro- | Tribromo- | Cerium | White | Black | White |
| | | acetate | Ethanol | anilino)-6- | ethanol | oxide | | | |
| | | | | dibutylamino- | | | | | |
| | | | | fluoran | | | | | |
| | 4 | Poly | Toluene/ | 2-(2-Chloro- | Tribromo- | Cerium | White | Black | White |
| | | (methacrylic | Ethanol | anilino)-6- | ethanol | oxide | | | |
| | | acid | | dibutylamino- | | | | | |
| | | | | fluoran | | | | | |

As clearly shown in Table 1, the color hues of the indicator sheets of Examples 1 to 7 were changed clearly after irradiating the radiation, and any color fading thereof was not observed after storing for three weeks. On the other hand, the color hues of the indicator sheets of Comparative Examples 1 to 4 were changed after irradiating the radiation, but the color fading thereof was observed after storing for three weeks.

Furthermore, an indicator sheet of another indicator of Example 1 was exposed to X-rays at the dose of 15 Gy using an X-ray exposure device: MBR-1520A-2 (available from Hitachi Medico Co., Ltd.). When the indicator sheet in the indicator was withdrawn and was inspected visually after the irradiation, it showed a color hue of black. After then, the radiation-irradiated indicator sheet in the indicator was stored in an incubator maintained at 40° C. for 3 weeks, and visually inspected for any change in its color hue similarly. The indicator sheet after storing in the incubator for 3 weeks showed a color hue of black, which was the same as the color hue showed after irradiating the X-ray. In addition, instead of the X-ray, when the indicator sheet was exposed to gamma-rays using a gamma-ray exposure device: Gammacell 1000 Elite (MDS: available from Nordion Co., Ltd.), the same result was obtained.

Next, Example of performing a method of dosimetry of exposed dose applying the present invention is mentioned below.

### DOSIMETRY EXAMPLE 1

The composition obtained in Example 1 was applied to a base material made of polyethylene, which had the adhesives in overleaf plane thereof, like layers, and was dried. The layer of the composition was covered with a transparent plastic film for avoiding the influence of moisture etc. It was cut into 1.5 cm square, to obtain a label of an exposed dose indicator whose color hue of the layer was white.

Prior to dosimetry of exposed dose, the standard color of the indicator was adjusted as follows. Some labels of the same kind of the exposed dose indicators prepared with the same procedure as mentioned above were respectively exposed beforehand to X-rays of different radiation dose, which was increased in every about 1 Gy in 0.5 to 5 Gy of radiation dose equivalent to the exposed dose used for an actual medical examination or treatment. The color hues of the layers of the indicators were changed from white to gray or black, corresponding to the radiation dose. These color hues for every radiation dose were determined as the standard colors of the indicator. A sample of the standard color of the indicator was prepared by printing the same color hues and the same contrasts of the color hues as the standard color using non-discoloring ink.

Next, the labels of another exposed dose indicator prepared with the same procedure as mentioned above were attached to the exposing body such as the skin of the patient, the clothing of the patient and the operating table when the actual medical examination or treatment using the X-ray was performed. When the medical examination or treatment using the X-ray was performed, the color hues of the labels of the exposed dose indicators changed corresponding to the exposed dose. The changed color hues of the labels were compared visually with that of the sample of the standard color of the indicator whose color hue differed for every radiation dose, and then the same color hues and the same contrasts of the color hues were found out from the sample. Consequently, the radiation dose showing the color hue was determined, so exposed dose of the patient was measured precisely and easily.

### DOSIMETRY EXAMPLE 2

Every four labels prepared in Dosimetry Example 1 were attached to each of a length and a width on a 20 cm square nonwoven fabric at equal intervals, to obtain a sheet as the exposed dose indicator. On the other hand, the sample of the standard color of the indicator the same as that of Dosimetry Example 1 was prepared.

Next, the sheets of the exposed dose indicators were attached to the exposing body such as the skin of the patient, the clothing of the patient and the operating table when the actual medical examination or treatment using the X-ray was performed. When the medical examination or treatment using the X-ray was performed, the color hues of the labels on the indicator sheets changed corresponding to the exposed dose. The changed color hues of the labels were compared visually with that of the sample of the standard color of the indicator whose color hue differed for every radiation dose. If the changed color hue of the label was more deep black, it showed that so much exposed dose was irradiated, so the exposed dose could be distinguished easily by visual. Consequently, the exposed dose, the exposed dose distribution and exposed area were judged visually, and were measured precisely and easily.

### DOSIMETRY EXAMPLE 3

Ten labels prepared in Dosimetry Example 1 were attached to the left side of the hat for an operation and the right side thereof at equal intervals, to obtain the hat as the exposed dose indicator.

Next, the patient wore the hat when the actual medical examination or treatment using the X-ray was performed. When the medical examination or treatment using the X-ray was performed, the color hue of the labels of the indicators on the hat changed corresponding to the exposed dose. The changed color hues of the labels were compared visually with that of the sample of the standard color of the indicator by the same procedure as Dosimetry Example 2. Consequently, the exposed dose, the exposed dose distribution and exposed area were judged visually, and were measured precisely and easily.

### DOSIMETRY EXAMPLE 4

The standard color of the indicator was adjusted by the same procedure as Dosimetry Example 1. Some labels of the exposed dose indicators were respectively exposed beforehand to X-rays of different radiation dose, which was increased in every about 1 Gy in 0.5 to 5 Gy of radiation dose equivalent to the exposed dose used for an actual medical examination or treatment. The color hues of the layers of the indicators were changed from white to gray or black, corresponding to the radiation dose. These color hues for every radiation dose were determined as the standard colors of the indicator. A color difference measurement about these color hues was performed, and then the calibration curve was prepared using the measured value of the color difference measurement and the radiation dose thereof.

Next, the labels of the exposed dose indicators prepared in the Dosimetry Example 1 were attached to the exposing body such as the skin of the patient, the clothing of the patient and the operating table when the actual medical examination or treatment using the X-ray was performed. When the medical examination or treatment using the X-ray was performed, the color hue of the labels of the exposed dose indicators changed corresponding to the exposed dose. The exposed dose was calculated and measured precisely and easily using the changed color hues of the labels, the measured value of the color difference measurement and the calibration curve.

### DOSIMETRY EXAMPLE 5

The labels as the exposed dose indicator prepared in Dosimetry Example 1 were arranged onto the medical examination or treatment table behind the patient at intervals of 5 cm. A thermoluminescence dosimeter (TLD) was put in the vicinity of it. The details of irradiation conditions, such as a perspective time thereof, a number of photography, a tube voltage, a tube current, and a filter, were recorded.

An incident surface dose of the patient calculated using an integration of the perspective time by a X-ray photography was 0.9 Gy when the medical examination or treatment using the X-ray was performed. On the other hand, the exposed dose measured by comparing the color hues using the labels as the exposed dose indicator by the same procedure as Dosimetry Example 3 was 0.9 Gy. The incident surface dose measured using TDL corresponded with the exposed dose measured using this indicator. Therefore, the accuracy of the exposed dose measured using the exposed dose indicator was shown.

### INDUSTRIAL APPLICABILITY

According to the radiation exposure history indicator sheet using the composition for the radiation exposure history indicator of the present invention, a radiation administrator can confirm that the radiation dose has been suitable when the radiation exposure treatments to the blood for transfusion or to the medical instrument are performed. Furthermore, according to the exposed dose indicator, the extensive cumulative exposed dose of the patient or the radiation engineer in case of the medical examination or treatment using the radiation can be measured correctly.

These indicators change their color hues clearly by irradiating the radiation. The indicators after changing colors never undergo any color fading for a long period of time, so the indicators can be stored as the evidence which shows that the desired radiation dose has been irradiated, for a long period of time.

These indicators can show the color change with a wide range of 0.05 Gy to 25000 Gy of radiation dose. These indicators can be manufactured easily and inexpensively.

Therefore, according to the method of dosimetry of the exposed dose of the present invention, the exposed dose of the patients can be measured locally or extensively, and easily, precisely and inexpensively on real time, when the medical examination or treatment, especially the Interventional Radiology is performed. Furthermore, the method of dosimetry of the exposed dose of the present invention can be used in a field of a radiation treatment or a field of a radiation research, as well as in a field of a medical examination or treatment using a radiation. And the exposed dose can be managed strictly because the history of the exposed dose is stored for a long period of time. So the medical examination or treatment using the radiation is performed much more safely.

1-18. (canceled)

19. A color fading inhibitor, which is contained in a color-changing layer of a radiation exposure history indicator as a medium with a radiation absorbent and/or a radiation-excite fluorescent agent, a coloring organic electron donor compound and an active species-generating organic compound for making the organic electron donor compound colored by a radiation, comprising a polymer compound having a hydroxyl group and at least one group selected from a halogen group and an acetal group.

20. The color fading inhibitor according to claim 19, wherein the polymer compound is at least one selected from
a polymer compound represented by the following chemical formula (1) 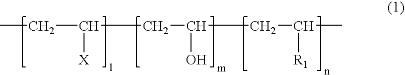
(in above formula, —X is a halogen atom; —R₁ is a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; I, m and n are arbitrary ratios), and
a polymer compound represented by the following chemical formula (2) 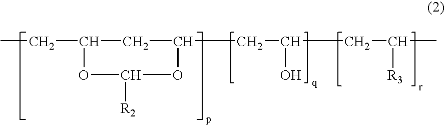
(in above formula, —R₂ and —R₃ are the same or different to each other, and are a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; p, q and r are arbitrary ratios).

21. A composition for a radiation exposure history indicator comprising:
5 to 50 parts by weight of a polymer compound having a hydroxyl group and at least one group selected from a halogen group and an acetal group,
0.01 to 50 parts by weight of a coloring organic electron donor compound,
0.1 to 50 parts by weight of an active species-generating organic compound for making the organic electron donor compound colored by a radiation, and
0.1 to 500 parts by weight of a radiation absorbent and/or a radiation-excite fluorescent agent.

22. A radiation exposure history indicator sheet comprising a color-changing layer in a mingled state on at least a part of the surface of a base material sheet comprising:
a coloring organic electron donor compound;
an active species-generating organic compound for making the organic electron donor compound colored by a radiation;
a color fading inhibitor comprising a polymer compound which inhibits color fading of the coloring by having a hydroxyl group and at least one group selected from a halogen group and an acetal group; and
a radiation absorbent and/or a radiation-excite fluorescent agent.

23. The radiation exposure history indicator sheet according to claim 22, wherein the polymer compound is at least one selected from
a polymer compound represented by the following chemical formula (1) 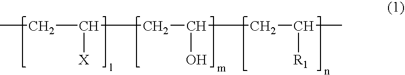
(in above formula, —X is a halogen atom; —R₁ is a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; I, m and n are arbitrary ratios), and
a polymer compound represented by the following chemical formula (2) 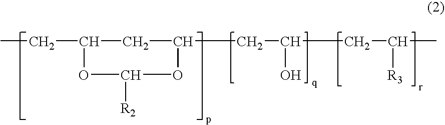
(in above formula —R₂ and —R₃ are the same or different to each other, and are a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; p, q and r are arbitrary ratios).

24. The radiation exposure history indicator sheet according to claim 22, comprising dye on at least a part of the color-changing layer, whose color hue of the dye is similar to the color hue of the color-changing layer observed prior to or after changing the color.

25. The radiation exposure history indicator sheet according to claim 22, wherein the color-changing layer is covered with a transparent or translucent protective film layer.

26. The radiation exposure history indicator sheet according to claim 25, comprising dye on at least a part of either side of the protective film layer, whose color hue of the dye is similar to the color hue of the color-changing layer observed prior to or after changing the color.

27. The radiation exposure history indicator sheet according to claim 22, wherein the base material sheet is also a protective film sheet, and an adhesive layer is provided on the non-observation plane of the protective film sheet.

28. The radiation exposure history indicator sheet according to claim 27, comprising dye on at least a part of either side of the protective film layer, whose color hue of the dye is similar to the color hue of the color-changing layer observed prior to or after changing the color.

29. The radiation exposure history indicator sheet according to claim 28, wherein another base material sheet is adhered to the adhesive layer.

30. The radiation exposure history indicator sheet according to claim 22, wherein an adhesive layer is provided on the non-observation plane of the base material sheet.

31. A method of dosimetry of exposed dose comprising steps of:
an exposed dose indicator containing a composition for a radiation exposure history indicator is attached to at least one of a exposing body selected from skin of a patient, a clothing for an operation, a hat for an operation, sheets for an operation for all over the surface thereof or with every regular intervals, and the exposing body is exposed;
after exposure, the exposed dose is measured by comparing a coloring of the exposed dose indicator with a standard color that radiation dose which is equivalent to the exposed dose was irradiated to the same kind of indicators and the indicators were colored beforehand.

32. The method of dosimetry of exposed dose according to claim 31, wherein the composition for a radiation exposure history indicator comprises:
a coloring organic electron donor compound;
an active species-generating organic compound for making the organic electron donor compound colored corresponding to the exposed dose;
a color fading inhibitor comprising a polymer compound which inhibits color fading of the coloring by having a hydroxyl group and at least one group selected from a halogen group and an acetal group; and
a radiation absorbent and/or a radiation-excite fluorescent agent in a mingled state, or comprises at least one compound selected from a polyacetylene compound and diarylethene compound.

33. The method of dosimetry of exposed dose according to claim 32, wherein the polymer compound is at least one selected from
a polymer compound represented by the following chemical formula (1) 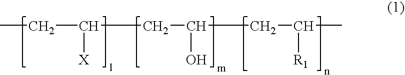
(in above formula, —X is a halogen atom; —R₁ is a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; I, m and n are arbitrary ratios), and
a polymer compound represented by the following chemical formula (2) 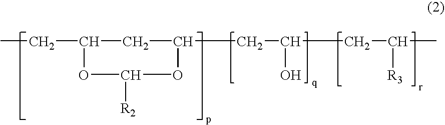
(in above formula, —R₂ and —R₃ are the same or different to each other, and are a hydrogen atom, a cyano group, an alkyl group, an aryl group, an alkoxyl group, an alkoxycarbonyl group, a fatty carbonyloxy group, a carboxyl group, an aryloxy group, an aralkyl group, an aralkoxyl group; p, q and r are arbitrary ratios).

34. The method of dosimetry of exposed dose according to claim 32, wherein the exposing body is exposed every time the radiation is irradiated, and then a cumulative total amount of exposed dose is calculated.

35. The method of dosimetry of exposed dose according to claim 32, wherein the colors are compared by comparing measured values of a color difference measurement, a concentration reflection measurement, an absorbance measurement, a transmittance measurement, or by visual observation.

36. The method of dosimetry of exposed dose according to claim 32, wherein the exposed dose indicator is a paint comprising the composition, a label having the composition, a sheet having the composition, or a molding having the composition.

37. The method of dosimetry of exposed dose according to claim 32, wherein the coloring is a change of a color hue, or a change of a contrast of a color hue.
